(19) United States
(12) Patent Application Publication
(10) Pub. No.: US 2013/0155645 A1
(43) Pub. Date: Jun. 20, 2013

(54) System and method for reducing glare

(71) Applicant: Tamas Marius, Monterey, CA (US)

(72) Inventor: Tamas Marius, Monterey, CA (US)

(21) Appl. No.: 13/374,280

(22) Filed: Dec. 19, 2011

(51) Int. Cl. F21V 9/14; G02B 5/30

(52) U.S. Cl. 362/19; 359/488.01

(57) ABSTRACT

A system and method for reducing glare by passing a beam of light emanating from a polarized light source through a polarizing filter having a polarization characteristic different from that of the light beam emanating from the polarized light source.

### FIELD OF THE INVENTION

The present invention relates generally to the field of light polarization systems. More particularly, the present invention relates to a system and method for reducing glare from a stationary or moving polarized light source using matched or unmatched polarized windshields or eyeglasses.

### BACKGROUND OF INVENTION & DESCRIPTION OF PRIOR ART

The prior art and automotive safety engineers have recognized the long-standing problems associated with the disabling effect of glare from the headlights of an approaching vehicle. The glare from the headlights of an oncoming vehicle may temporarily blind drivers moving in the opposite or same direction causing them to lose control of their vehicles. Similarly, this glare may cause objects of low illumination or visibility to temporarily disappear from the other driver's field or vision thereby putting both the other driver and the object at risk. At the very least, the headlight glare from an oncoming vehicle can be annoying, cause driver fatigue, or lead to headaches or other physical discomfort.

The safety problems associated with the glare from the headlights of an approaching vehicle have been exacerbated by federally mandated safety standards that now require vehicle headlights that are brighter and have a wider beam pattern than older headlights manufactured in the 20^{th} Century. Further, the proliferation of minivans and sport utility vehicles and the steady increase in the use of large trucks for interstate and intrastate commerce have introduced a significant number of vehicles with headlights positioned directly in line with an automobile driver's field of vision.

Not surprisingly, the prior art provides an extensive list of devices designed to deal with this problem of headlight glare. Some devices fell into the strobe type of glare reduction systems whereby the headlights of an approaching vehicle are rapidly flashed on and off and the operators of other vehicles viewed the roadway through visors that were rapidly switched between light emissive and opaque states in synchronization with the oncoming headlights. For example, U.S. Pat. No. 4,286,308 issued to Wolff (1981) disclosed an improved glare control system where the headlights of an oncoming vehicle were rapidly switched between emissive and non-emissive states and the operator of the other vehicle views the roadway through a visor that has transmissive and opaque states operating in synchronization with the switching mechanism in the oncoming vehicle.

Other prior art examples addressed the problem of headlight glare by using specially configured optical filters. One system disclosed in the prior art contemplates a system using two matching linearly polarized filters; one filter is placed on or near the headlight of a vehicle and the other is placed on or near the windshield or visor of another vehicle. U.S. Pat. No. 1,786,518 issued to Chambers (1930) and U.S. Pat. No. 2,458,179 issued to Land (1949) are examples of prior art disclosing such configurations.

Other systems found in the prior art contemplate the use of matching circularly or elliptically polarized filters. While successful in reducing or even eliminating the headlight glare from an approaching vehicle, these systems also reduced the intensity of the light from the headlights of the other drivers' vehicles. U.S. Pat. No. 6,646,801 issued to Sley (2003) addresses this problem and discloses the use of unmatched (e.g., circular/linear or elliptical/linear) polarizing filters to achieve glare reduction while avoiding the illumination and visibility losses associated with prior, conventional polarization systems.

These devices relied upon the use of polarizers, generally in the form of a stand-alone polarized lens or filter or a sheet of transparent polarized material that would be applied externally to a light source or a light receiver. A polarizer is simply a device that Converts a beam of light which is a form of electromagnetic energy having non-specific or undefined polarization into a light beam having specific or well-defined polarization. Polarizing can be accomplished by a wire grid to absorb or reflect the non-desired electromagnetic waves. Certain crystals display the characteristic of dichroism which is the preferential absorption of light which is polarized in various, non-specific directions. Some polarizers are made of polyvinyl alcohol (PVA) sheeting which is stretched during manufacture so that its PVA molecular components are aligned in a particular direction. When applied to a light transmitter or receiver, the PVA sheeting will absorb light parallel to the chains and permit passage of only that portion of the light beam that is perpendicular to the chains. Despite this variety and variability, all polarizers accomplish the same function namely allowing only those beams of a specific orientation or definition to pass through the device.

When two polarizers are aligned so that the orientation of the first polarizer is identical to that of the second polarizer, an observer viewing light that has passed through the two polarizers will see light of normal brightness and intensity. However, if the second polarizer is rotated with respect to the first polarizer, the second polarizer begins to reflect, absorb, or otherwise filter out light that has passed through the first polarizer. As the rotation of the second polarizer continues, the orientation of the second polarizer moves farther away from being parallel to that of the first polarizer and closer to being perpendicular to the orientation of the first polarizer. Accordingly, as this rotation continues, more and more light passing through the first polarizer is filtered out by the second polarizer until the point where no light passes through the second polarizer. By controlling the angular relation of the orientation of the second polarizer to the orientation of the first polarizer, it is possible to select the desired amount of light that passes through the second polarizer: anywhere from 100 percent to no light at all. This rotation of the second polarizer to limit the brightness and intensity of light viewed by an observer viewing light that has passed through both polarizers is the essence of glare reduction using polarizing filters.

These devices discussed in the foregoing paragraphs, as well as others found in the prior art, all required that one polarizing filter be placed on or near the light source of the oncoming vehicle, i.e., an incandescent light bulb which constituted the oncoming vehicle's headlamp. Accordingly, some of these devices contemplated a polarizing filter that was a separate lens, mounted inside the headlamp assembly of the oncoming vehicle, and positioned between the incandescent light bulb and the clear outer lens sealing the headlamp cavity. Other devices found in the prior art contemplated a separate polarizing filter in the form of a thin film or sheet of polarizing material applied to the incandescent light bulb in the headlamp cavity or the clear outer lens sealing the headlamp cavity on the oncoming vehicle. In essence, this thin film of polarizing material was applied as a coating to the light source itself, which was typically an incandescent light bulb, or the clear outer lens sealing the headlamp cavity.

The devices disclosed by the prior art also required that another separate polarizing filter be placed near the driver of the other vehicle such as on the windshield or on a movable transparent visor on the driver's side of the vehicle. While some devices disclosed by the prior art contemplated a separate polarizing filter standing alone, most devices found in the prior art contemplated a separate polarizing filter in the form of a thin film or sheet of polarizing material applied to the windshield of the other car or the movable transparent visor on the driver's side. In essence, this thin film of polarizing material was (again) applied as a coating to the windshield of the other car or the movable transparent visor on the driver's side. Alternatively, some prior art examples disclosed eyeglasses worn by the driver of the other vehicle as a polarizing filter on the receiving end of the headlight beam.

While these prior art devices solved the problem of reducing headlight glare, they all had one significant shortcoming in that they all required separate polarizing filters that would either stand apart from the light source or the driver of the other vehicle or be applied as a coating to a light source, a protective lens, a windshield, a visor, or the like. The fact that these devices are not in widespread use suggests that they did not solve the problem to the satisfaction of the general consuming public or that they were in some way unacceptable to the general consuming public. Specifically:
(1) Polarizing filters that stand alone and apart from the light source and/or the windshield or that are applied to the light source and/or the windshield add one or more components to the glare reduction systems disclosed by the prior art.
(2) Polarizing filters that stand alone or that are applied to the light source and/or the windshield increase the complexity of glare reduction systems such as those disclosed by the prior art making them more expensive to manufacture which would, in turn, make glare reduction systems using stand-alone polarizing filters more expensive to the consumer.
(3) Polarizing filters that stand alone or that are applied to the light source and/or the windshield are more likely to malfunction or be damaged which, in turn, makes glare reduction systems using stand-alone polarizing filters more expensive to maintain.
(4) Stand-alone polarizing filters are easily lost, stolen, or otherwise misappropriated which, in turn, would render any glare reduction systems relying upon such misappropriated stand-alone polarizing filters (such as those disclosed by the prior art) unusable.
(5) Polarizing filters that are applied to a light source, windshield, or the like are susceptible to cracking, peeling, tearing, deformation, and other such problems which, in turn, make glare reduction systems using applied-coating polarizing filters more expensive to maintain because the component (headlight, lens, windshield, etc.) supporting the damaged or deformed coating must be replaced.
(6) Polarizing filters that are applied to a light source, windshield, or the like are susceptible to cracking, peeling, tearing, deformation, and other such problems which, in turn, render glare reduction systems using applied-coating polarizing filters ineffective until the old filter was scraped off and replaced with a new applied-coating polarizing filter or until the component to which the filter was applied was replaced.
(7) Polarizing filters that stand-alone and apart from the light source and/or the windshield add one or more steps to the process of reducing headlight glare from an oncoming vehicle.
(8) Polarizing filters that are applied to or coated on the light source and/or the windshield add one or more steps to the process of reducing headlight glare from an oncoming vehicle.

### OBJECTS AND ADVANTAGES

The present invention seeks to overcome all of these shortcomings with an improved glare reduction system that is simple in design, easy and inexpensive to manufacture, flexible in its installation, and of durable construction, while still meeting the stated needs of the consumer for a reasonably priced automotive feature. Accordingly, the objects and advantages of the present invention are:

(1) To provide a glare reduction system that will overcome the shortcoming of the prior art devices.

(2) To provide glare reduction system that is simple to manufacture, economical in price and easy to maintain.

(3) To provide a glare reduction system that has no moving parts.

(4) To provide a glare reduction system that is simple in design, easy and inexpensive to manufacture, easy and safe to use, and commercially reasonable in price.

(5) To provide a glare reduction system that eliminates the need for a stand-alone polarizing filter.

(6) To provide a glare reduction system that eliminates the need for an applied-coating polarizing filter.

(7) To provide a glare reduction system that integrates the polarizing filter into the light source of the vehicle's headlight thereby creating a polarized light source.

(8) To provide a polarizing light filter that also integrates a second polarizing filter into, the windshield of a vehicle.

The features of the present invention were designed to accomplish these goals. The following description of the present invention and the accompanying drawings disclose these features in sufficient detail to allow one skilled in the art to practice the present invention. The following descriptions and accompanying drawings describe only a few of the possible applications of the present invention. The present invention is intended to include these applications, their equivalents, as well as other applications not specifically identified herein. Additional objects, advantages, and novel features of the invention will be set forth in part of the description which follows and will become apparent to those skilled in the art upon examination of the following specification, or will be learned through the practice of the present invention.

### DRAWINGS

### Drawing Figures

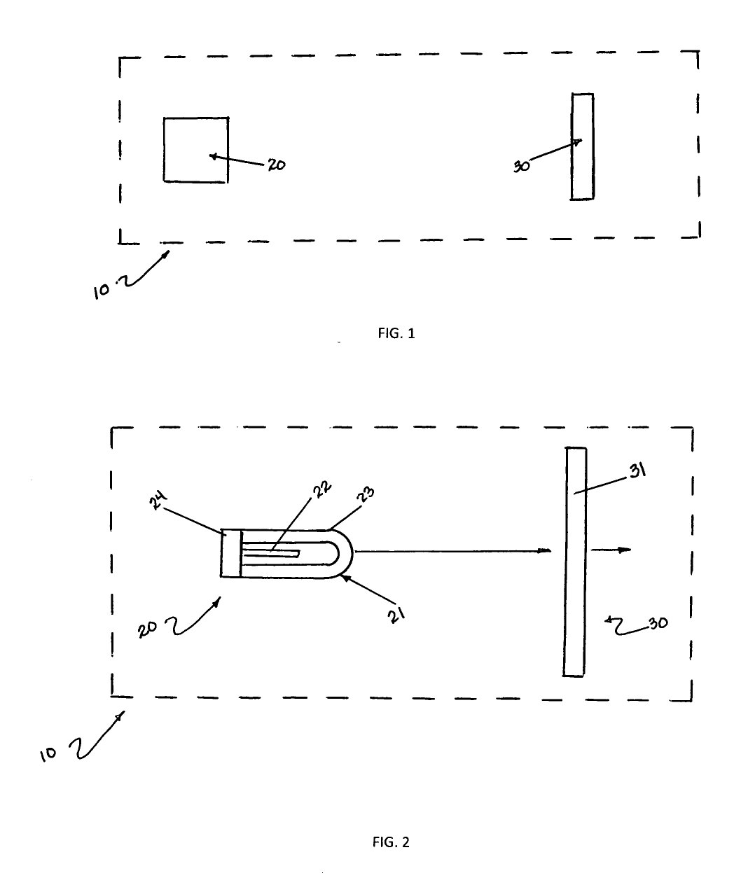

FIG. 1 is a schematic drawing of the glare reduction system

FIG. 2 is a schematic drawing of the components of the glare reduction system

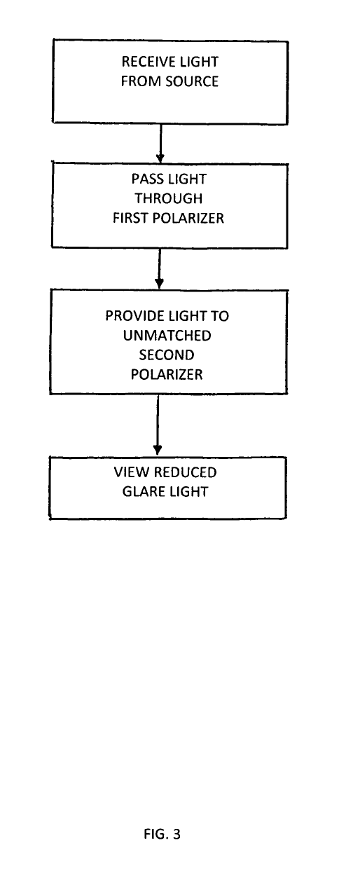

FIG. 3 is a flow chart diagram illustrating the methodology for glare reduction found in the prior art.

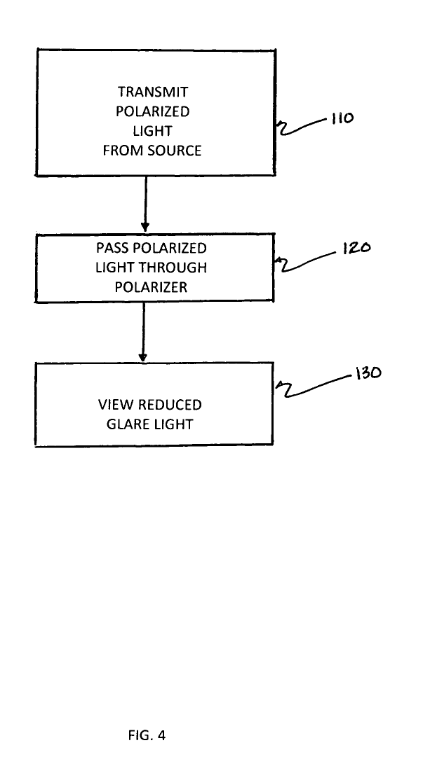

FIG. 4 is a flow chart diagram illustrating the methodology for glare reduction in accordance with the present invention.

### REFERENCE NUMERALS

10—Glare reduction system
20—Polarized light transmitter
21—Polarized light source
22—Filament
23—Polarized glass bulb
24—Light bulb base
30—Polarized light receiver-filter
31—Polarized reception screen

### DESCRIPTION OF THE INVENTION

While the present invention contemplates an application or primary use as a safety enhancement feature for the automobile industry, it has applications in other fields as well. In fact, the present invention can be used in any situation where safety or comfort concerns mandate the reduction of glare coming from the lights of an approaching or stationary source. Accordingly, it has applications in commercial aviation or other forms of commercial or private transportation, building construction, and interior or exterior lighting to name a few. In all of these applications, the essence of the present invention is the integration of a polarizing filter into both the transmitting and the receiving ends of the glare reduction system.

Referring to FIG. 1, the basic glare reduction system 10 is comprised of a polarized light transmitter 20 and a polarized light receiver-filter 30. The polarized light transmitter 20 emits a beam of polarized light that is received and filtered by the polarized light receiver-filter 30. The polarized light receiver-filter 30 is a polarizing filter that is aligned with respect to the polarized light transmitter 20 so as to allow only a specified percentage of polarized light emanating from the polarized light transmitter 20 to pass through the polarized light receiver-filter 30.

Referring to FIG. 2, the polarized light transmitter 20 is a polarized light source 21 containing a filament 22 encased or embedded within a polarized glass bulb 23 which is to say, a bulb made of polarized glass. The polarized light receiver-filter 30 is a polarized reception screen 31 made of polarized glass; i.e., it is essentially a polarizing filter. Again, the polarized reception screen 31 is aligned so as to permit a specified and predetermined amount of polarized light coming from the polarized light source 21 to pass through.

The polarized light source 21 generates a polarized light beam. However, because of the design and construction of the present invention, the light beam coming from the filament 22 is polarized at the instant it is generated because the polarized light source 21 uses a polarized glass bulb 23 that is constructed using polarized glass instead of regular glass. This polarized light beam emanating from the polarized light source 21 appears to be of normal brightness, intensity, and luminescence to the naked eye. However, when this polarized light beam passes through the polarized light receiver 30, it is filtered once again, this time by the polarized reception screen 31 which, as mentioned previously, is just another polarizing filter. However, the alignment of the polarized light source 21 and the polarized reception screen 31 with respect to one another is such that a only a predetermined amount of light originating from the polarized light source 21 will reach an observer on the other side of the polarized reception screen 31.

In one embodiment of the present invention, the polarized light source 21 is an incandescent light bulb similar to those which have been the automobile industry standard since automobiles were first manufactured in the early 20^{th} Century. However, the present invention calls for the use of polarized glass instead of the industry-standard transparent glass used in the manufacture most incandescent bulbs. In this embodiment, the filament 22 is hermetically sealed and encased or embedded in a compartment defined by the light bulb base 24 and the polarized glass bulb 23. Since the polarized glass bulb 23 is constructed of polarized glass, there is no need to coat it with a polarizing filter as taught by the prior art examples. Eliminating the need to coat the light source with a polarizing filter saves time and money in the manufacture of the light source. Further, since the polarizing filter is integrated into the light source itself, problems such as cracking, peeling, tearing, deformation, and the like are avoided.

The polarized reception screen 31 could is typically a windshield made of polarized glass, a movable and transparent visor made of polarized glass, a window made of polarized glass, or eyeglasses having polarized lenses therein. However, any aperture or opening fitted with polarized glass or polarizing lenses will function as a polarized reception screen 31. In all configurations, the polarized reception screen 31 is aligned with respect to the polarized light source 21 in such a manner as to permit a predetermined amount (percentage) of polarized light coming from the polarized light source 21 to pass through.

In another embodiment, the polarized light source contemplates the use of a light emitting diode (“LED”). In this configuration, the filament 22 is the LED which is embedded in the polarized glass bulb 23. Because of the nature of LEDs, this configuration has a longer duration because the LED does not burn out as quickly as the industry-standard incandescent light bulb.

### Operation of the Invention

FIG. 3 is a flow chart diagram illustrating an example of the methodology for glare reduction found in the prior art. While not exclusive, it representative of the methodology for glare reduction as taught by the prior art. Basically, an unfiltered (non-polarized) light beam is received from source such as a headlight, stadium light, and/or display screen. This light beam is then passed through the first polarizer which the prior art describes as either a stand-alone polarizing filter or a film of polarizing material that is physically applied to the source of the non-polarized light. The light from the first polarizer is then passed through a second (in this case, unmatched) polarizer. After the light passes through the second polarizer, it is viewed by an observer as having reduced glare. The methodology described in this example from the prior art is typical of other systems taught by the prior art in that it has four distinct steps: receive (or transmit) non-polarized light, pass the non-polarized light through a first polarizer, pass the light through a second polarizer, and finally, view the reduced-glare light.

In operation of the present invention, the present invention eliminates one of those four distinct steps by combining the transmission of non-polarized light and the first-filtering of that non-polarized light into a single, simultaneous step. Referring to FIG. 4, the present invention transmits polarized light from the source 110 thereby eliminating the prior-art step of first-filtering non-polarized light. The present invention then passes this polarized light through a polarizer 120 that is aligned to permit a specific, predetermined amount of polarized light to pass through. Then, this filtered polarized light is viewed as reduced glare light 130 by an observer.

### CONCLUSIONS, RAMIFICATIONS, AND SCOPE

The foregoing paragraphs describe an invention that has successively overcome the shortcomings experienced by practitioners of the prior art. The present invention provides the consumer with a glare reduction system that is simple in design, easy and inexpensive to manufacture, flexible in its installation, and of durable construction, while still meeting the stated needs of the consumer for a reasonably priced automotive feature. Accordingly, the present invention:

(1) Provides a glare reduction system that has overcome the shortcoming of the prior art devices.

(2) Provides glare reduction system that is simple to manufacture, economical in price and easy to maintain.

(3) Provides a glare reduction system that has no moving parts.

(4) Provides a glare reduction system that is simple in design, easy and inexpensive to manufacture, easy and safe to use, and commercially reasonable in price.

(5) Provides a glare reduction system that eliminates the need for a stand-alone polarizing filter.

(6) Provides a glare reduction system that eliminates the need for an applied-coating polarizing filter.

(7) Provides a glare reduction system that integrates the polarizing filter into the light source of a vehicle's headlight thereby creating a polarized light source.

(8) Provides a polarizing light filter that also integrates a second polarizing filter into the windshield or other such aperture of a second vehicle.

As mentioned previously, the present invention contemplates an application or primary use as a safety enhancement feature for the automobile industry; however, it has applications in other fields as well. In fact, the present invention can be used in any situation where safety or comfort concerns mandate the reduction of glare coming from the lights of an approaching or stationary source. Accordingly, it has applications in commercial aviation or other forms of commercial or private transportation, building construction, and interior or exterior lighting to name a few. The present invention can also be adapted for another application in of aviation safety: that of diminishing the debilitating effect of a laser pointed at the cockpit of an incoming or departing aircraft. In this application, the laser pointer would be modified to emit a polarized laser beam that would pass through an appropriately aligned polarized cockpit windshield. In all of these applications, the essence of the present invention is the integration of a polarizing filter into both the transmitting and the receiving ends of the glare reduction system.

What is claimed is:

1. A system for reducing glare comprising:
a. a polarized light transmitter; and
b. a polarized light receiver-filter aligned with respect to said polarized light transmitter so as to permit a predetermined percentage of polarized light waves emitted by said polarized light transmitter to pass through said polarized light receiver-filter.

2. The device according to claim 1 wherein said polarized light transmitter is a polarized light source, said polarized light source being an incandescent light bulb having a filament encased or embedded in a space defined by a light bulb base and a polarized glass bulb comprised of polarized glass and said polarized light receiver-filter is an automobile windshield comprised of polarized glass.

3. The device according to claim 1 wherein said polarized light transmitter is a polarized light source, said polarized light source being an incandescent light bulb having a filament encased or embedded in a space defined by a light bulb base and a polarized glass bulb comprised of polarized glass and said polarized light receiver-filter is a movable and transparent automobile visor comprised of polarized glass.

4. The device according to claim 1 wherein said polarized light transmitter is a polarized light source, said polarized light source being an incandescent light bulb having a filament encased or embedded in a space defined by a light bulb base and a polarized glass bulb comprised of polarized glass and said polarized light receiver-filter is a pair of eyeglasses having polarized lenses inserted therein.

5. The device according to claim 1 wherein said polarized light transmitter is a polarized light source, said polarized light source being a light-emitting-diode bulb having a light-emitting-diode encased or embedded in a space defined by a light bulb base and a polarized glass bulb comprised of polarized glass and said polarized light receiver-filter is an automobile windshield comprised of polarized glass.

6. The device according to claim 1 wherein said polarized light transmitter is a polarized light source, said polarized light source being a light-emitting-diode bulb having a light-emitting-diode encased or embedded in a space defined by a light bulb base and a polarized glass bulb comprised of polarized glass and said polarized light receiver-filter is movable and transparent automobile visor comprised of polarized glass.

7. The device according to claim 1 wherein said polarized light transmitter is a polarized light source, said polarized light source being a light-emitting-diode bulb having a light-emitting-diode encased or embedded in a space defined by a light bulb base and a polarized glass bulb comprised of polarized glass and said polarized light receiver-filter is a pair of eyeglasses having polarized lenses inserted therein.

8. A method of using a headlight glare reduction system as described in claim 1 comprising the steps of:
a. transmitting a beam of polarized light from a polarized light source;
b. passing said beam of polarized light through a polarizer aligned with respect to said polarized light source so as to permit a predetermined percentage of polarized light waves emitted by said polarized light source to pass through said polarizer; and
c. viewing said beam of polarized light as reduced glare light.
